(19) United States
(12) Patent Application Publication
(10) Pub. No.: US 2010/0044941 A1
(43) Pub. Date: Feb. 25, 2010

(54) FIXED SUPPORT FOR PARTS IN MACHINE TOOLS

(75) Inventors: Andre Greffioz, Capdenac (FR); Michel Vives, Aucamville (FR)

Correspondence Address: Perman & Green, LLP, 99 Hawley Lane, Stratford, CT, 06614, US

(73) Assignee: AIRBUS FRANCE, Toulouse (FR)

(21) Appl. No.: 12/441,190

(22) PCT Filed: Sep. 21, 2007
(86) PCT No.: PCT/FR07/51995

§ 371 Date: Oct. 15, 2009

(30) Foreign Application Priority Data
Sep. 21, 2006 (FR) 0653876

(51) Int. Cl. B23Q 3/00

(52) U.S. Cl. 269/9

(57) ABSTRACT

A fixed carrier for machine tool parts includes a table frame and a table having a first face That can hold a first part to be machined, the first face being fixed above a machining device and the first part being stationary during the machining process. The table also has a second face for holding steady a second part to be machined.

### CROSS-REFERENCE TO RELATED APPLICATIONS

This application is the National Stage of International Application No. PCT/FR2007/051995, International Filing Date 21 Sep. 2007, which designated the United States of America and which International Application was published under PCT Article 21 (2) as WO Publication No. WO2008/035021 A1 and which claims priority to French Application No. 06 53876, filed 21 Sep. 2006, the disclosures of which are incorporated herein by reference in their entireties.

### BACKGROUND

1. Field

The disclosed embodiments belong to the field of machine tools for machining workpieces having to be held fixed during the machining process, in particular for large-sized workpieces. More particularly, the disclosed embodiments relate to a fixed workpiece support which makes it possible to prepare one workpiece in hidden time during the machining of another workpiece.

2. Brief Description of Related Developments

When it is required to machine large-sized workpieces which are very heavy and generally have complex shapes, use is made of customized machine tools.

Conventional machine tools have a fixed horizontal table which is tailored to the dimensions of the workpiece to be machined and which is held on a highly rigid base. The workpiece is fastened to an upper face of the table. Furthermore, the machine tool has a movable gantry in the shape of an inverted U that carries one or more machining heads positioned above the workpiece.

However, the complexity involved in moving the machining heads with the precision required by the machined workpieces results in a gantry which is generally very heavy to move, greatly limiting the speeds of travel, mainly during movements outside the machining time.

To improve the productivity of this type of gantry machine tool, a known solution consists in working in hidden time, that is to say in carrying out a workpiece preparation operation on workpieces that are to be machined while the machine tool is performing a machining operation on other workpieces. Thus, while the machine is machining one set of workpieces on one part of the table, another set of workpieces is prepared on another part of the table. This hidden-time preparation avoids having to immobilize the gantry during the preparation operations but, on the other hand, entails at least doubling the required length of the machining table and hence occupying a much greater floor area in the workshop. For example, in the case of workpieces generally measuring a few meters, these machine tools may extend to several tens of meters in length in order to allow hidden-time working.

The use of a table for holding large-sized workpieces immobile whereby it is possible to work in hidden time without multiplying the floor area would therefore be beneficial in terms of increasing the storage capacity of machine tools in a workshop and hence in terms of increasing industrial productivity.

### SUMMARY

The disclosed embodiments provide a fixed workpiece support for machine tools that comprises a table frame and a table comprising a first face capable of holding a first workpiece to be machined, said first face being fixedly positioned above a machining carriage and said first workpiece being immobile during the machining process. The table comprises, in addition, a second face capable of similarly holding a second workpiece to be machined.

In the support according to the aspects of the disclosed embodiments, the table is reversible such as to render the two faces of said table interchangeable.

The table is positioned in the table frame, which comprises an opening tailored to the dimensions of the table, such that the first workpiece is machined on one face and the second workpiece is prepared on the other face. Thus, the workpiece preparation operation performed in hidden time on the other face of the table makes it possible not to increase the floor area of the machine tool.

To immobilize the workpiece to be machined during the machining operation, the support comprises means for fastening the table to the table frame in order to immobilize the table on said table frame during the machining operation. Said fastening means may be flanges and/or locks and/or locking keys and/or bearing points.

In one aspect of the disclosed embodiments, in order to facilitate the operations of turning over the table, the table comprises an axis of rotation which is substantially parallel to the two faces of the table and whose axis-defining pivot is mounted on bearings fastened to said table.

Preferably, in order to minimize the spacing, between the table and the opening of the table frame, required for rotating the table, the cross section of the opening of the frame, perpendicular to the axis of rotation, is a circular arc centered on said axis.

Preferably, in order to prevent objects or tools from falling during machining operations, the support also comprises sealing means between the table and the table frame.

### BRIEF DESCRIPTION OF THE DRAWINGS

The detailed description of the aspects of the disclosed embodiments is given with reference to the figures, in which:

FIG. 1a shows a schematic perspective view of a support for workpieces to be machined according to the aspects of the disclosed embodiments,

FIG. 1b shows a cross section of the same support for workpieces to be machined according to the aspects of the disclosed embodiments,

FIG. 2 shows a cross section of a support for workpieces to be machined according to the aspects of the disclosed embodiments, illustrating one example of a reversible table,

FIG. 3a shows a schematic perspective view of a workpiece support comprising a pivoting reversible table according to the aspects of the disclosed embodiments,

FIG. 3b shows a longitudinal section of the same workpiece support comprising a pivoting reversible table according to the aspects of the disclosed embodiments,

FIG. 3c shows a cross section of the same workpiece support comprising a pivoting reversible table according to the aspects of the disclosed embodiments,

FIG. 3d shows a cross section of a workpiece support comprising a pivoting reversible table according to the aspects of the disclosed embodiments, illustrating one example of the table frame opening cross section.

### DETAILED DESCRIPTION OF THE DISCLOSURE EMBODIMENTS

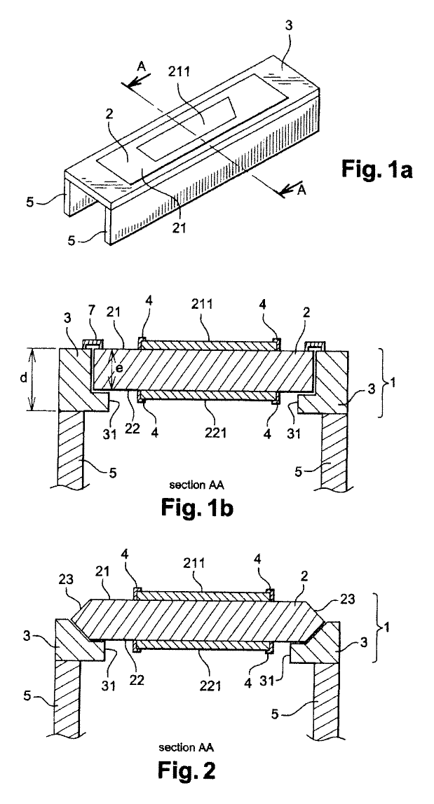

According to the aspects of the disclosed embodiments, a fixed workpiece support 1 for machine tools, as illustrated in FIGS. 1a, 1b, comprises a table frame 3 and a table 2 having:
a first face 21 capable of holding a workpiece 211 to be machined in a fixed position,
a second, upper, face 22, opposed and substantially parallel to said first face 21, capable of holding a workpiece 221 to be machined in a fixed position.

The support 1 is substantially horizontal, and the table 2 has a length at least equal to the length of the largest workpiece to be machined.

The support 1 has sufficient rigidity to ensure that the table is stable when workpieces are being machined.

To ensure that the workpiece to be machined is held on the table with sufficient rigidity, retaining means 4, such as, for example, flanges, are arranged in a conventional manner on each of the faces 21, 22 of the table 2.

During the machining operations, the table 2 is held on the table frame 3. Said table frame is built with sufficient rigidity to support said table and the workpieces 211, 221.

The support 1 is placed such that the workpiece to be machined can be machined by a movable machining device, advantageously placed below said support. For example, the support 1 is itself fastened to two vertical walls 5 which hold it at the desired constant height with respect to the machining device.

The table 2 and the table frame 3 are secured, in particular during the machining operations, in order that the workpiece 211 in the process of being machined is perfectly immobilized.

In one aspect of the disclosed embodiments, one method consists, for example, in using a table frame 3, with a thickness d greater than the thickness e of the table 2, having an opening designed to receive the table 2 such that said table rests on a rim 31 of the frame or on protruding elements of the opening which accommodates the table 2.

In another aspect of the disclosed embodiments, as illustrated in FIG. 2, the table frame 3 has an opening, comprising bearing points of oblique cross section, designed to receive a table 2 having ends 23 with a triangular cross section which is complementary to the cross section of the opening. The table 2 rests on a frame rim 31 or on inwardly protruding elements of the opening which accommodates the table.

In order to position and immobilize the table in the frame and hence hold the workpiece fixed during the machining operation, fastening means 7, such as flanges or locks, are arranged so as to fasten the table to the table frame.

Other means, for example a system of keys (not shown), may be used to position and immobilize the table on the table frame.

Furthermore, the table frame 3, the ends 23 of the table and the means 7 for fastening said table to said frame are arranged such that, in one fixed position, the first face 21 corresponds to a lower face of the table 2 and the second face 22 corresponds to an upper face of the table and, in a second position, the first face 21 is the upper face of the table and the second face 22 the lower face. Thus, it is possible to machine one workpiece on one of the two faces 21, 22 of the table 2 and to prepare another workpiece on the other face of the table. This hidden-time operation can be performed directly on the support without increasing the floor area of the machine tool in the workshop.

The table face used is advantageously the face in the upper position since it requires the intervention of operators, and the workpiece, when it is not yet held by flanges, is not at risk of falling when it is placed on the table.

In order to facilitate handling and also the operations of cleaning the table, the upper face of the table is preferably substantially level with or above the table frame.

To turn over the table 2, in particular when a workpiece 211 has been machined on a first face 21 and when a workpiece 221 to be machined has been prepared on a second face 22, a lifting means (not shown) can be used. In a first step, the table 2 is raised out of the table frame 3, then, in a second step, it is turned over, and finally, in a third step, it is repositioned in the frame 3 so as to be immobilized once more therein.

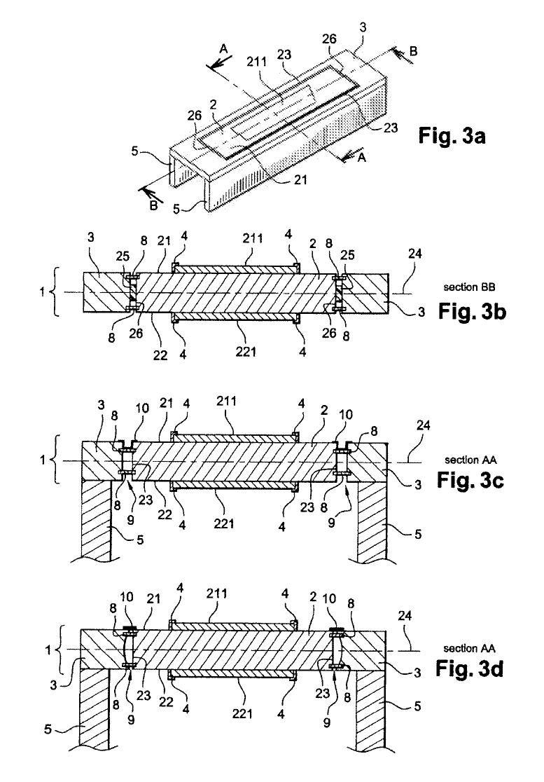

In order to facilitate this turning-over operation, other means may be employed. In one variant embodiment, illustrated in FIGS. 3a, 3b, 3c, the table 2 pivots about an axis of rotation 24, corresponding substantially to its longitudinal axis. The axis of rotation 24 preferably has its axis-defining pivot mounted on bearings, and the rotational movement may, where appropriate, be provided by means of motors or actuators 25 situated, for example, at the two ends 26 of said table.

Advantageously, the table 2 is held in said fixed position by locking means 8 fastened to the table frame 3. Said locking means, in a first position, hold the table 2 in a fixed working position and, in a second position, release the table 2 such that said table can pivot. Inverting the position between the two faces 21, 22 takes place by rotating the table 2 by 180° about the axis 24.

Preferably, the table frame 3 has an opening whose dimension allows the rotation of the table 2 about the axis 24 without having to raise said table. In that case, a space 9 is created between the ends 23 of said table and the table frame 3, as illustrated in FIG. 3c.

In order to prevent tools or various objects from falling during preparation operations on a workpiece, a situation which can make it necessary to shut down the machining operations, and to avoid the risk of cutting oil mist rising during the machining process, the space is advantageously closed by a cover seal 10 placed around the table 1 prior to the start of the machining operation.

In one variant aspect of the disclosed embodiments, as illustrated in FIG. 3d, the cross section of the opening of the table frame 3 perpendicular to the axis of rotation corresponds to a circular arc centered on the axis of rotation 24. This configuration makes it possible to limit the space 9 between the ends 23 of the table and the opening of the table frame.

The disclosed embodiments thus make it possible to obtain a fixed workpiece support for machine tools for machining workpieces which have to be held immobile during the machining process, whereby it is possible to prepare one workpiece in hidden time during the machining of another workpiece without multiplying the occupied floor area.

What is claimed is:

1. A fixed workpiece support for machine tools, comprising a table frame and a table comprising a first face capable of holding a first workpiece to be machined, said first face being fixedly positioned above a machining device, and said first workpiece being immobile during the machining process, wherein the table also comprises a second face capable of holding immobile a second workpiece to be machined.

2. The support as claimed in claim 1, wherein the table is reversible such as to render the two faces interchangeable.

3. The support as claimed claim 1, wherein the table is positioned in the table frame, which comprises an opening tailored to the dimensions of the table, such that the first workpiece is machined on one face and the second workpiece is prepared on the other face.

4. The support as claimed claim 1, comprising means for fastening the table such as to immobilize the table on the table frame during the machining operation.

5. The support as claimed in claim 4, wherein the fastening means comprise flanges and/or locks and/or locking keys and/or bearing points.

6. The support as claimed claim 1, wherein the table comprises an axis of rotation which is substantially parallel to the faces of the table and whose axis-defining pivot is mounted on bearings fastened to said table.

7. The support as claimed in claim 6, wherein a cross section of the opening of the table frame, perpendicular to the axis of rotation, is a circular arc centered on said axis.

8. The support as claimed claim 1, comprising sealing means between the table and the table frame.
